(19) United States
(12) Patent Application Publication
(10) Pub. No.: US 2013/0311298 A1
(43) Pub. Date: Nov. 21, 2013

(54) TARGETED AUDIO STREAM

(71) Applicant: Ramy S. Ayoub, Arlington Heights, IL (US)

(72) Inventor: Ramy S. Ayoub, Arlington Heights, IL (US)

(73) Assignee: GENERAL INSTRUMENT CORPORATION, Horsham, PA (US)

(21) Appl. No.: 13/474,885

(22) Filed: May 18, 2012

(51) Int. Cl. G06F 15/16; G06Q 30/02

(52) U.S. Cl. 705/14.66; 709/231

(57) ABSTRACT

A system and method is configured to receive a single video stream, synchronized with multiple audio streams, from a content producer. In addition, viewer information is received from a client device; and viewer profile information is retrieved. The client device is provided instructions to switch to one of the multiple audio streams that closely correspond to the viewer profile information, while maintaining the same video stream and synchronization.

### FIELD OF THE DISCLOSURE

The present disclosure relates generally to distribution of synchronized video and audio content and more particularly to reducing bandwidth associated with the synchronized video and audio content.

### BACKGROUND

Targeted advertising over a multi-media outlet has become a lucrative and effective method of increasing the efficiency of the advertising content. Advertisers continue to parse their content based on demographics. Where possible, advertisers would like to be able to target a wide range of demographics with the same advertising. Notably, in order to perform targeted advertising, the advertisers and service providers conventionally store and distribute a large number of advertisements for an on-demand use.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an example system in accordance with one or more embodiments.

FIG. 2 is another block diagram of another example system in accordance with some embodiments.

FIG. 3 is an example flowchart for a method according to one or more embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A system and method is described herein for reducing required bandwidth for targeted viewer programming. The method includes receiving a single video stream with synchronized multiple audio streams from a content producer; receiving viewer information from a client device; and retrieving viewer profile information. Instructions are provided to the client device to switch to one of the synchronized audio streams that closely corresponds to the viewer profile information, while maintaining the same video stream. Accordingly, one or more embodiments enable or address There is a need to provide targeted advertising to a wide ranging audience or set of users, while retaining the normal bandwidth usage or refraining from substantially increasing bandwidth usage by delivering the targeted advertising to the wide ranging audience or set of users or viewers of multimedia content that view the multi media content on varied and numerous content display devices.

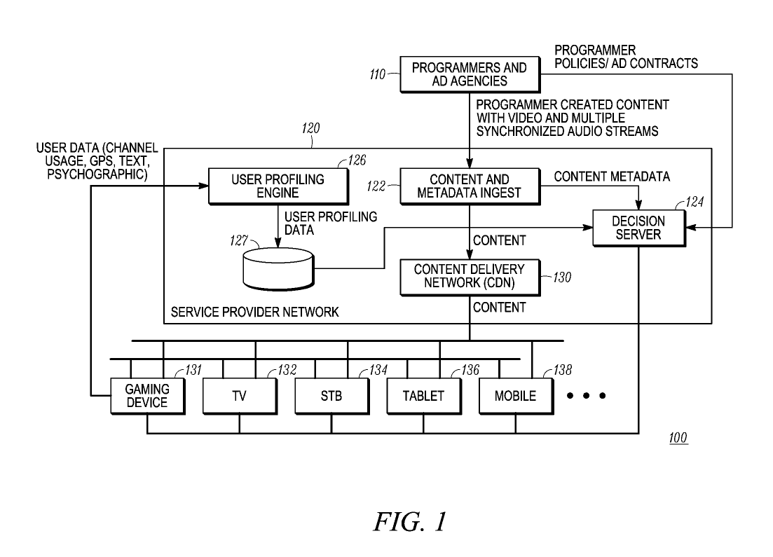

FIG. 1 is a block diagram of an example system 100 comprising a service provider network 120 configured to receive programmer created content 110 from, for example, programmers and advertising (“ad”) agencies. The programmers and ad agencies operate under their own policies and adhere to contractual relationships with the service provider. The programmer created content 110 comprises a single video stream with multiple synchronized audio streams. A timestamp may be employed to enable synchronization, however, other means for synchronizing may be employed as well, including adding markers, analyzing signal parameters, such as frequency and harmonics, for example.

Service provider network 120 in FIG. 1 also includes a content and metadata component 122, a decision server 124, a user profiling engine 126, and a content delivery network (CDN) 130. The content and metadata component 122 receives the programmer created content 110 and forwards relevant content metadata that enables decision server 124 to decide or analyze what type of content to deliver to what kind of client device. The content metadata may stay with the content for possible downstream usage or consumption, such as by a multimedia player, for example. The content metadata from content and metadata component 122 also is transmitted to the CDN 130 for subsequent distribution of content to various types and numbers of client devices.

The user profiling engine 126 provides user profiling data 127 subject to the various types and numbers of client devices. For example, the user profiling data 127 can include channel usage data, location data, textual data, and psychographic data. The user profiling data 127 is transmitted or communicated to decision server 124 to aid in decision server's analysis. The user profiling engine can reside in a backend server of a service provider such as a wireless company. Likewise, the decision server 124 can also reside in a backend server.

Various types and numbers of client devices can be communicatively coupled to CDN 130 for receiving content via wired or wireless means. For example, a gaming device 131, a television 132, a set-top box (STB), a tablet computing device, a mobile communication device 138 (also sometimes referred to industry as a mobile computing device, such as a smartphone) can be connected or coupled all at once or individually to a the CDN 130. The client devices are configured to send their user identification and current program information to decision server 124 upon detection of new program information (i.e., a channel change) or receipt of an advertising marker in the delivered content. In response, the decision server 124 returns audio stream process identification to the client devices as relevant information for tuning the client devices to the “correct” audio channel corresponding to the connected client device. The “correct” audio channel can be selected based on user profile such as gender, age, viewing habits or history, and time of day data, for example. In addition, the “correct” audio channel can be selected based on user profile coupled with advertising data that certain ads are more effective for certain users or viewers at certain times of day, for example. That is the audio stream is targeted for a specific audience after having been selected from multiple available audio streams from the programmer. Intelligent software code that resides in the backend server can select the audio stream targeted for a specific audience; thereby obviating any user interaction regarding the selection of the targeted audio. In addition, the intelligent software code can cause a return to a predetermined default audio stream or a select a different program identifier (PID) for another distinct advertising segment.

Regarding the multiple types of client devices, such as a gaming device 131, a television 132, a set-top box 134, a tablet computer 136, and mobile communication device 138, for example, the various client devices each can be communicatively linked to decision server 124 such that decision server 124 is capable of receiving user identification and current program information from the client devices.

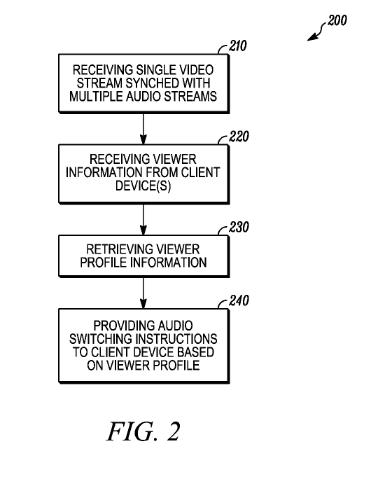

FIG. 2 illustrates an example flowchart 200 for reducing required bandwidth for targeted viewer programming. Flowchart 200 includes operation 210 that enables receiving a single video stream with synchronized multiple audio streams from a content provider. In one embodiment, the multiple audio streams can be created and appended with a timestamp for synchronization and control at the production stage of the media content. In another embodiment, the timestamp for synchronization may be appended further downstream in the process, including at the set-top box or multi-media player. The multiple audio streams can be in different languages or voices. The multiple audio streams may also contain different narrative content, targeted towards a plurality of user profiles. Operation 220 enables receiving viewer information from a client device. The viewing information can include subscriber identification or the name of the media content viewer, for example. Operation 230 enables retrieving viewer profile information. The viewer profile information can be retrieved from internal or external sources. For example, the viewer profile information can be stored internally in a memory location or stored remotely at a server site. Additionally, the viewer profile information can be supplied by the viewer or user of the media content via a flashdrive, memory chip or card, DVD, or CD, for example. The viewer profile information can include characterizing data associated with and including, for example, viewer's ethnicity, age, gender, psychographic, political, or historical viewing information. Operation 240 enables providing instructions to the client device to switch to one of the synchronized audio streams that closely correspond to the viewer profile information, while maintaining the same video stream.

The synchronized audio streams of Operation 240 may be synchronized using different streaming protocols with timestamps. For example, a MPEG2 transport stream with timestamp can be used to synchronize, with the video stream, the multiple audio streams provided from media programmers or ad agencies. Likewise, a real-time transport protocol (RTP) with timestamp can be used to synchronize, with the video stream, the multiple audio streams provided from media programmers or ad agencies.

Operations 210-240 may be implemented in a non-transitory computer readable device or medium. The device or medium further includes stored thereon a computer program that may include several code sections that enable or are configured to perform operations 210-240 as shown in FIG. 2.

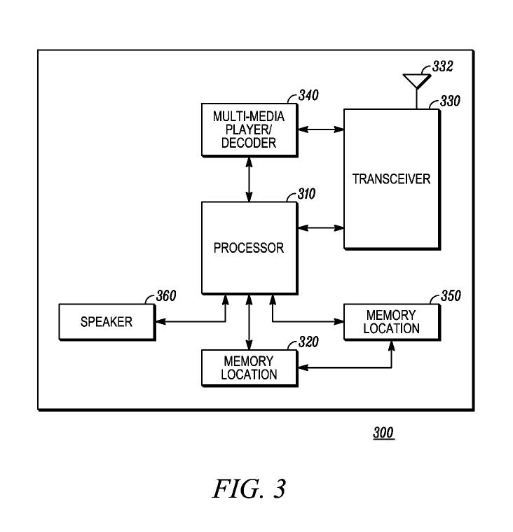

FIG. 3 illustrates, by way of example, a client device 300. Client device 300 can include a processor communicatively coupled to a memory location 320, and also communicatively coupled to a transceiver 330 having an antenna 332. An application specific programmed code or software entity, entitled a program detector codecan also be configured to run in the processor 310 for client device 300, or alternatively reside at least temporarily in memory location 320 of client device 300, or an external memory location. The program detector code is configured to determine any change in the media content. For example, if a program station is changed, then the media content that the program station was playing is in most likelihood changed when the program station changes. The program changes may be done as normal, planned, content changes within a specific channel, for example, during advertisement breaks or changes in content. Program changes may also be user initiated by changing channels, or requesting different Video On Demand content. The change can be, for example, in content or other content-specific parameters relevant to the display or presentation of the content such as hue, chroma, saturation, resolution, illumination, audio, pitch, decibels, brightness, etc.

Memory location 320 can be employed to store a media content viewer's corresponding identification and profile. The media content viewer's identification can include subscriber identification or the name of the media content viewer, for example. The media content viewer's profile can include data associated with and including viewer's ethnicity, age, gender, race, psychographic, political, or historical viewing information. Processor 310 of client device 300 can be configured to control a transmission of the media content viewer's corresponding identification and profile to a decision server (shown in FIG. 1), for example, that is communicatively coupled to a service provider network. Processor 310 can be further configured to receive from the decision server a selected audio stream identification based on the media content viewer's corresponding identification and profile. The selected audio stream identification having been associated with one of several audio streams that were synchronized to a single video stream.

A multimedia player 340 (also sometimes referred to in industry as a decoder) is an inclusive component of the client device 300. The multimedia player 340 can be configured to receive instructions from the processor 310 regarding which encoded video and audio streams to decode from within a received MPEG2-TS or RTP multimedia stream, for example. Therefore, multimedia player 340 can be configured to dynamically switch between several audio streams for a single video stream for subsequent synchronized audio and video playout.

Playout or presentation of multimedia content can occur on a display 350 configured to receive a video stream and thereafter display or present the video stream. Display 350 can be a touchscreen, but need not be so. Display 350 can be an LED, LCD, OLED, AMOLED, super-AMOLED, or an equivalent display technology, including plasma technology, for example.

Playout or presentation multimedia content can occur via a speaker 360. Speaker 360 can be a single speaker or a group of speakers. Speaker 360 can be configured to receive and emit audio. The audio can be one of several audio streams that may have been selected or identified based on a media content viewer's corresponding identification and profile, for example. The selected audio stream to be emitted from speaker 360 is synchronized with the single video stream displayed on display 350 and that had been provided by a content provider at a content provider access point.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Likewise, computer-readable storage medium can comprise a non-transitory machine readable storage device, having stored thereon a computer program that include a plurality of code sections for performing operations, steps or a set of instructions.

Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for reducing required bandwidth for targeted viewer programming, comprising:
receiving a single video stream, synchronized with multiple audio streams, from content producer;
receiving viewer information from a client device;
retrieving viewer profile information; and
providing instructions to the client device to switch to one of the multiple audio streams that closely correspond to the viewer profile information, while maintaining same video stream and synchronization.

2. The method according to claim 1, the viewer profile information comprising data associated with and including viewer's ethnicity, age, gender, psychographic, political, or historical viewing information.

3. The method according to claim 1, the multiple audio streams synchronized using different streaming protocols with timestamps.

4. The method according to claim 3, wherein MPEG2 transport stream with timestamp is used to synchronize the multiple audio streams with the same video stream.

5. The method according to claim 3, wherein real-time transport protocol (RTP) with timestamp is used to synchronize the multiple audio streams with the same video stream.

6. The method according to claim 1, the client device is selected from a group comprising tablets, smartphones, gaming devices, PCs, TVs, and set-top boxes (STBs).

7. The method according to claim 1, the viewer information comprising subscriber ID or name of viewer.

8. A system, comprising:
content provider access point coupled to a backend server;
the backend server comprising a memory location for viewer profiles and also an analysis processor for receiving viewer information from a client device for use in retrieving viewer profile information and selecting a view profile, and for matching the viewer profiles with a targeted audio advertising stream selected from multiple audio streams synchronized with a single video stream;
a content distribution network for providing content from a content provider via the content provider access point coupled with the selected targeted audio advertising stream and also an unselected targeted audio advertising stream to the client device configured to receive the selected targeted audio advertising stream and the single video stream in a synchronized manner.

9. The system according to claim 8, wherein the content provider access point is configured to receive the content from a group selected from an advertising agency, broadcaster, movie studios, and online movie distribution sites.

10. A client device configured to receive media content within a service provider network, comprising:
a program detector code for determining change of the media content;
a memory location for storing a media content viewer's corresponding identification and profile;
a transceiver for transmitting the media content viewer's corresponding identification and profile to a decision server communicatively coupled to the service provider network;
a processor for controlling the transceiver, and configured to run the program detector code;
the processor also configured to receive from the decision server a selected audio stream identification based on the media content viewer's corresponding identification and profile, the selected audio stream identification being associated with one of several audio streams received by the client device that were received with and synchronized to a single video stream;
a speaker for outputting a selected audio stream based on the selected audio stream identification; and
a display for outputting the single video stream synchronized with the selected audio stream.

11. The client device according to claim 10, further comprising a multimedia player/decoder capable of dynamically switching between a plurality of audio streams for the single video stream for audio and video playout on the client device.

12. The client device according to claim 10, wherein the client device is a multimedia content device.

13. The client device according to claim 12, wherein the client device is a tablet computer.

14. The client device according to claim 10, wherein the client device is a smartphone.

15. The client device according to claim 10, wherein the client device is a gaming device.

16. A non-transitory machine readable storage device, having stored thereon a computer program that includes a plurality of code sections comprising:
code for receiving a single video stream, synchronized with multiple audio streams, from content producer;
code for receiving viewer information from a client device;
code for retrieving viewer profile information; and
code for providing instructions to the client device to switch to one of the multiple audio streams that closely correspond to the viewer profile information, while maintaining same video stream and synchronization.
